(19) United States
(12) Patent Application Publication
(10) Pub. No.: US 2010/0092101 A1
(43) Pub. Date: Apr. 15, 2010

(54) METHODS AND APPARATUS FOR ENHANCING IMAGE QUALITY OF MOTION COMPENSATED INTERPOLATION

(76) Inventors: Chin-Chuan Liang, Taichung City (TW); Te-Hao Chang, Taipei City (TW); Siou-Shen Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/248,048

(22) Filed: Oct. 9, 2008

(51) Int. Cl. G06K 9/40; G06K 9/32

(52) U.S. Cl. 382/260; 382/300

(57) ABSTRACT

A method for enhancing image quality of motion compensated interpolation includes generating an interpolated frame according to at least two source frames by analyzing motion estimation information of the two source frames. The method further includes: regarding a pixel under consideration within the interpolated frame, selectively performing post filtering according to motion estimation information of a region where the pixel is located. Accordingly, an apparatus for enhancing image quality of motion compensated interpolation is also provided.

### BACKGROUND

The present invention relates to motion compensated interpolation, and more particularly, to methods and apparatus for enhancing image quality of motion compensated interpolation.

Please refer to FIG. 1. FIG. 1 is a diagram of a frame rate conversion circuit 10 coupled to a display device 20 according to the related art. A conventional method for implementing operations of the frame rate conversion circuit 10 is converting a source frame rate of the source frames shown in FIG. 1 into a display frame rate of frames to be output to the display device 20 by frame repetition, typically causing judder and blur of moving object(s)/background since the corresponding frame repetition operations are typically unfaithful image conversions. As a result, the corresponding display results of the display device 20 are unacceptable to users.

In order to solve the above-mentioned problem, a conventional architecture of the frame rate conversion circuit 10 shown in FIG. 1 was proposed as shown in FIG. 2, where an input signal 8 shown in FIG. 2 carries source frames input into the conversion circuit 10 shown in FIG. 1, and an output signal 18 shown in FIG. 2 carries interpolated frames output from the conversion circuit 10 shown in FIG. 1. According to the conventional architecture shown in FIG. 2, the frame rate conversion circuit 10 comprises a motion estimator 12 and a motion compensated interpolator 14. The motion estimator 12 generates motion vectors according to the source frames. The motion compensated interpolator 14 performs motion compensated interpolation according to the motion vectors carried by an intermediate signal 13 from the motion estimator 12 in order to generate the interpolated frames.

The conventional architecture shown in FIG. 2 converts a source frame rate of the source frames into a display frame rate of the interpolated frames by the motion compensated interpolation instead of the aforementioned frame repetition. All the interpolated frames that are generated by the motion compensated interpolator 14 and sent to the display device 20 are calculated according to different time moments, causing smoother motion images than those from the aforementioned frame repetition operations. However, side effects such as some visible artifacts may occur while applying motion compensated interpolation.

It should be noted that the motion vectors from the motion estimator 12 sometimes do not faithfully represent the true object motion, causing visible artifacts in the interpolated frames, such as so-called “broken artifacts” and so-called “halo artifacts”. For example, regarding the broken artifacts, the motion vectors corresponding to a complex motion area such as that having running legs may be incorrect, so the display results corresponding to the interpolated frames will be unacceptable. In another example regarding the halo artifacts, as there are typically covered and uncovered areas for two video objects with different motion directions, the motion vectors may be incorrect, leading to unacceptable display results.

While applying motion compensated interpolation, side effects such as some visible artifacts may occur due to erroneous motion vectors from the motion estimator 12 and/or complexity of the image content of the source frames.

### SUMMARY

It is therefore an objective of the claimed invention to provide methods and apparatus for enhancing image quality of motion compensated interpolation to solve the above-mentioned problems.

It is another objective of the claimed invention to provide methods and apparatus for enhancing image quality of motion compensated interpolation, in order to reduce artifacts of motion compensated interpolation.

An exemplary embodiment of a method for enhancing image quality of motion compensated interpolation comprises: generating an interpolated frame according to at least two source frames by analyzing motion estimation information of the two source frames; and regarding a pixel under consideration within the interpolated frame, selectively performing post filtering according to motion estimation information of a region where the pixel is located.

An exemplary embodiment of an apparatus for enhancing image quality of motion compensated interpolation comprises a motion compensated interpolator and an adaptive post filter that is coupled to the motion compensated interpolator. The motion compensated interpolator generates an interpolated frame according to at least two source frames by analyzing motion estimation information of the two source frames. In addition, regarding a pixel under consideration within the interpolated frame, the adaptive post filter selectively performs post filtering according to motion estimation information of a region where the pixel is located.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a frame rate conversion circuit coupled to a display device according to the related art.

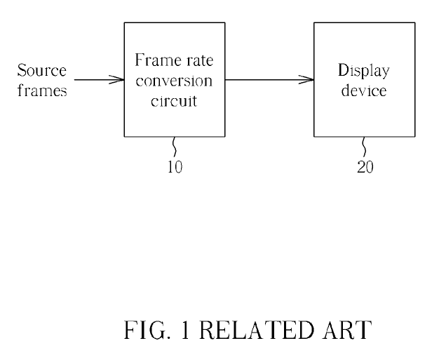

FIG. 2 is a diagram of a conventional architecture of the frame rate conversion circuit shown in FIG. 1.

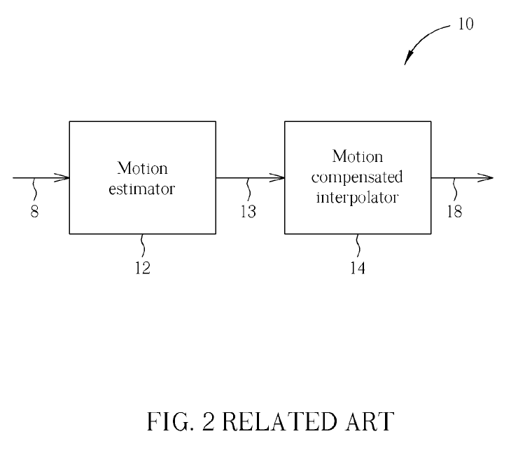

FIG. 3 is a diagram of an apparatus for enhancing image quality of motion compensated interpolation according to a first embodiment of the present invention.

FIG. 4 illustrates exemplary frames respectively carried by some of the signals shown in FIG. 3.

FIG. 5 illustrates exemplary data of an interpolated frame and corresponding data respectively in a previous frame and a current frame regarding a specific pixel processed by the motion compensated interpolator shown in FIG. 3.

FIG. 6 illustrates an exemplary boundary between pixels considered by the adaptive post filter shown in FIG. 3 according to the first embodiment.

FIG. 7 illustrates an example of the boundary shown in FIG. 6, where the foreground and the background of the image shown in FIG. 7 correspond to two opposite motion vectors, respectively.

FIG. 8 illustrates another example of the boundary shown in FIG. 6, where the boundary shown in FIG. 8 is a boundary between an MC area and a non MC area.

FIG. 9 illustrates two exemplary boundaries between pixels considered by the adaptive post filter shown in FIG. 3 according to a variation of the first embodiment.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

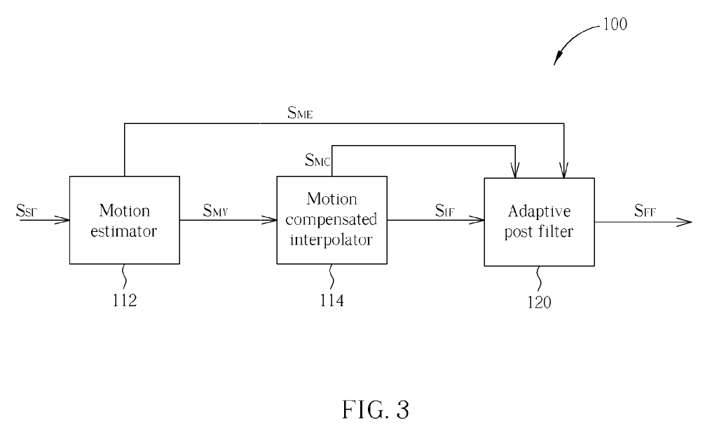

Please refer to FIG. 3. FIG. 3 is a diagram of an apparatus 100 for enhancing image quality of motion compensated interpolation according to a first embodiment of the present invention. The apparatus 100 comprises a motion estimator 112, a motion compensated interpolator 114, and an adaptive post filter 120. The motion estimator 112 generates motion vectors according to source frames carried by an input signal S_{SF} shown in FIG. 3. In addition, the motion compensated interpolator 114 generates an interpolated frame according to at least two source frames of those from the input signal S_{SF} by analyzing motion estimation information of the two source frames, where the motion estimation information of this embodiment represents motion vectors such as those carried by an intermediate signal S_{MV} shown in FIG. 3.

Additionally, regarding a pixel under consideration within the interpolated frame, the adaptive post filter 120 selectively performs post filtering according to motion estimation information of a region where the pixel is located. More particularly, the adaptive post filter 120 selectively performs the post filtering according to some criteria regarding the motion estimation information of the region. For example, when the motion vector of the pixel under consideration is zero, the adaptive post filter 120 determines to not perform the post filtering. In another example, when the motion vectors of the region are zero, i.e. the motion vectors of all the pixels within the region are zero, the adaptive post filter 120 determines to not perform the post filtering.

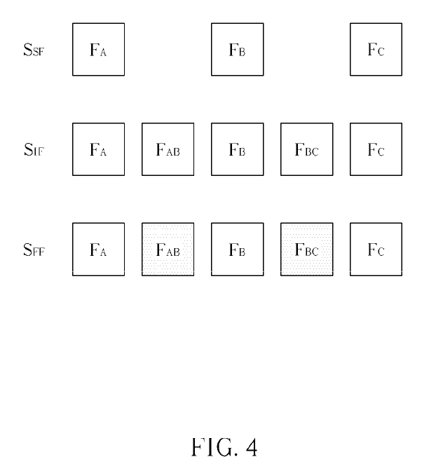

FIG. 4 illustrates exemplary frames respectively carried by some of the signals shown in FIG. 3. As shown in FIG. 4, source frames F_{A}, F_{B}, and F_{C} are carried by the input signal S_{SF} shown in FIG. 3 and bypassed by the motion estimator 112 and the motion compensated interpolator 114, so another intermediate signal S_{IF} shown in FIG. 3 also carries the bypassed source frames F_{A}, F_{B}, and F_{C}. The motion compensated interpolator 114 performs motion compensated interpolation according to the source frames F_{A}, F_{B}, and F_{C} to generate interpolated frames F_{AB} and F_{BC}. The motion compensated interpolator 114 outputs the bypassed source frames F_{A}, F_{B}, and F_{C} and the interpolated frames F_{AB} and F_{BC} at respective time points, so the frames F_{A}, F_{AB}, F_{B}, F_{BC}, and F_{C} carried by the intermediate signal S_{IF} are subsequently input into the adaptive post filter 120.

As mentioned, the adaptive post filter 120 selectively performs the post filtering. That is, the interpolated frames F_{AB} and F_{BC} may be filtered by the adaptive post filter 120 in a first situation, or bypassed by the adaptive post filter 120 in a second situation. For brevity, the corresponding filtered frames of the interpolated frames F_{AB} and F_{BC} in the first situation and the bypassed interpolated frames F_{AB} and F_{BC} in the second situation are illustrated with dotted blocks having the notations of F_{AB} and F_{BC} labeled thereon, respectively. Thus, in this embodiment, the adaptive post filter 120 outputs the bypassed source frames F_{A}, F_{B}, and F_{C} and the filtered/bypassed interpolated frames F_{AB} and F_{BC} at respective time points through an output signal S_{FF} shown in FIG. 3. As a result, the frames F_{A}, F_{AB}, F_{B}, F_{BC}, and F_{C} carried by the output signal S_{FF} are subsequently transmitted from the adaptive post filter 120 into a display device coupled to the adaptive post filter 120, and are displayed with the aforementioned artifacts being reduced or removed.

Referring to FIG. 3 again, the adaptive post filter 120 of this embodiment is capable of receiving the motion estimation information carried by another intermediate signal S_{ME} shown in FIG. 3 and further receiving motion compensation information carried by another intermediate signal S_{MC} shown in FIG. 3, where the motion compensation information of this embodiment represents blending factors utilized during the aforementioned motion compensated interpolation. Some details regarding the blending factors are described as follows.

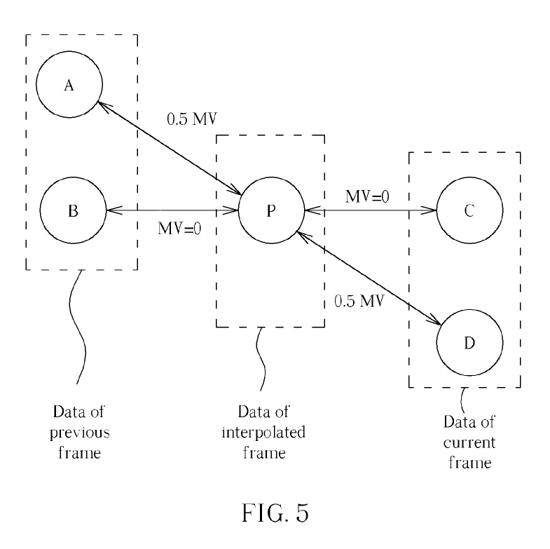

FIG. 5 illustrates exemplary data P of an interpolated frame (e.g. the interpolated frame F_{AB} or the interpolated frame F_{BC}) and corresponding data A, B, C, and D respectively in a previous frame and a current frame regarding a specific pixel processed by the motion compensated interpolator 114 shown in FIG. 3. For example, when the data P represents data in the interpolated frame F_{AB}, the data A and B represent the corresponding data in source frame F_{A} and the data C and D represent the corresponding data in source frame F_{B}. In another example, when the data P represents data in the interpolated frame F_{BC}, the data A and B represent the corresponding data in source frame F_{B} and the data C and D represent the corresponding data in source frame F_{C}.

In this embodiment, the motion compensated interpolator 114 performs motion compensated interpolation (i.e. MC interpolation) by blending a non-MC interpolation component ((B+C)/2) and an MC interpolation component ((A+D)/2) with a blending factor k to generate a blending result (i.e. the data P) as follows:

P=(l−k)*((B+C)/2)+k*((A+D)/2);

where the blending factor k may vary according to different implementation choices of this embodiment. For example, the blending factor k can be described according to the following equation:

k=(α*|B−C|)/(β*|B+C−A−D|+δ);

where α and β represent coefficients for controlling the magnitude of k with respect to the non-MC interpolation component ((B+C)/2) and the MC interpolation component ((A+D)/2), and δ is a relatively small value for preventing the denominator in the above equation from being zero. In another example, the blending factor k is equal to α divided by variance of motion vectors of neighboring pixels, where α in this example represents a coefficient. In another example, the blending factor k can be calculated as follows:

k=α/(β*|A−D|+δ);

where α and β in this example represent coefficients for controlling the magnitude of k, and δ in this example is a relatively small value for preventing the denominator in the above equation from being zero.

According to the aforementioned motion estimation information and/or the motion compensation information, the adaptive post filter 120 determines whether/where/how to perform the post filtering for all the interpolated frames carried by the intermediate signal S_{IF} individually. As a result, the aforementioned visible artifacts such as the broken artifacts and the halo artifacts can be greatly reduced or removed without degrading image details.

According to this embodiment, the post filtering represents blurring processing. More particularly in this embodiment, according to the motion estimation information and even the motion compensation information, the adaptive post filter 120 selectively performs low pass filtering on the region where the pixel under consideration is located to generate a filtered value of the pixel. Here, the low pass filtering is described with a low pass filtering function LPF_{X} as follows:

LPF_{X}(Pixel(X_{—}LB), . . . , Pixel(X_{—}UB))=Σ_{X}_{_{—}}_{LB}^{X}^{UB} PV_{X}*W_{X};

where the subscript X represents a pixel location along the X-direction, X_LB and X_UB respectively represent a lower bound and an upper bound of the pixel location along the X-direction within the region, PV_{X} represents a pixel value of a pixel at a specific pixel location X, and W_{X} represents a weighted value for the pixel at the specific pixel location X. For example, X_LB and X_UB are respectively equal to (X₀−2) and (X₀+2) with X₀ representing the pixel location of the pixel under consideration, and the corresponding weighted values can be 1, 2, 2, 2, and 1, respectively.

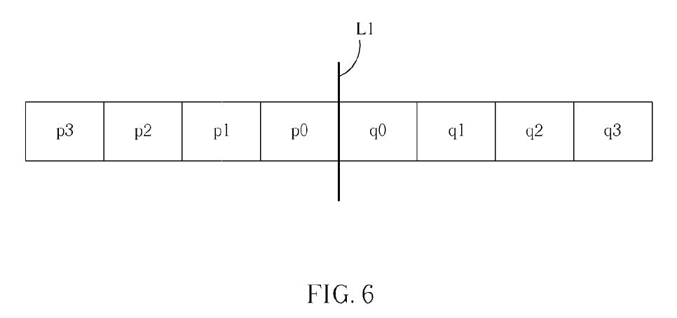

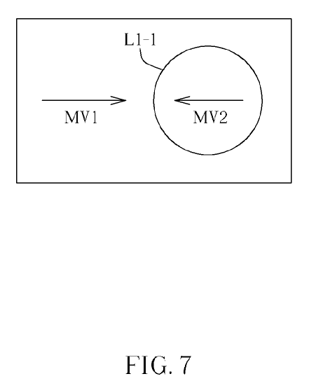

Please refer to FIG. 6 and FIG. 7. FIG. 6 illustrates an exemplary boundary L1 between pixels p0 and q0 considered by the adaptive post filter 120 shown in FIG. 3, where p3, p2, p1, p0, q0, q1, q2, and q3 represent a plurality of pixels arranged along the X-direction, and the aforementioned region may comprise one or more pixels of those shown in FIG. 6. FIG. 7 illustrates an example of the boundary L1 shown in FIG. 6, i.e. the boundary L1-1, where the foreground and the background of the image shown in FIG. 7 correspond to two opposite motion vectors MV2 and MV1, respectively.

According to a first implementation choice of this embodiment with reference to FIG. 7, for the adjacent pixel pair p0 and q0, when an absolute value of a difference between the motion vector MV(p0) of the pixel p0 and the motion vector MV(q0) of the pixel q0 is greater than a threshold th1, i.e. the situation where |MV(p0)−MV(q0)|>th1 occurs, the adaptive post filter 120 respectively sets two flags FTX(p0) and FTX(q0) regarding the pixels p0 and q0 as a first logical value ‘1’ (i.e. FTX(p0)=1 and FTX(q0)=1), indicating that the post filtering should be performed regarding the pixels p0 and q0. In addition, with a threshold th2 being greater than the threshold th1, when the absolute value of the difference between the motion vector MV(p0) of the pixel p0 and the motion vector MV(q0) of the pixel q0 is greater than the threshold th2, i.e. the situation where |MV(p0)−MV(q0)|>th2 occurs, the adaptive post filter 120 respectively sets two flags FTX(p1) and FTX(q1) regarding the pixels p1 and q1 as the first logical value ‘1’ (i.e. FTX(p1)=1 and FTX(q1)=1), indicating that the post filtering should be performed regarding the pixels p1 and q1. It should be noted that there is an exception for setting these flags as mentioned above. When a motion vector MV(n) of a specific pixel n out of the pixels p1, p0, q0, and q1 is zero, i.e. the situation where MV(n)=0 occurs, the adaptive post filter 120 forcibly sets the flag FTX(n) regarding the pixel n as a second logical value ‘0’ (i.e. FTX(n)=0), indicating that the post filtering should not be performed regarding the pixel n.

Thus, the adaptive post filter 120 determines whether to bypass the pixel value of the pixel under consideration or generates the filtered value of the pixel under consideration according to the flag FTX( ) regarding the pixel. For example, if the flag FTX(p0) is set as the first logical value ‘1’, the adaptive post filter 120 generates the filtered value PV′(p0) of the pixel p0 as follows:

PV′(p0)=LPF(p2, p1, p0, q0, q1).

In addition, if the flag FTX(p1) is set as the first logical value ‘1’, the adaptive post filter 120 generates the filtered value PV′(p1) of the pixel p1 as follows:

PV′(p1)=LPF(p3, p2, p1, p0, q0).

Similarly, if the flag FTX(q0) is set as the first logical value ‘1’, the adaptive post filter 120 generates the filtered value PV′(q0) of the pixel q0 as follows:

PV′(q0)=LPF(p1, p0, q0, q1, q2).

In addition, if the flag FTX(q1) is set as the first logical value ‘1’, the adaptive post filter 120 generates the filtered value PV′(q1) of the pixel q1 as follows:

PV′(q1)=LPF(p0, q0, q1, q2, q3).

Regarding the aforementioned exception, when the situation where MV(n)=0 occurs, indicating that the pixel n is in a still image area, the pixel value of the pixel n will be bypassed. That is, no filtered value of the pixel n will be generated.

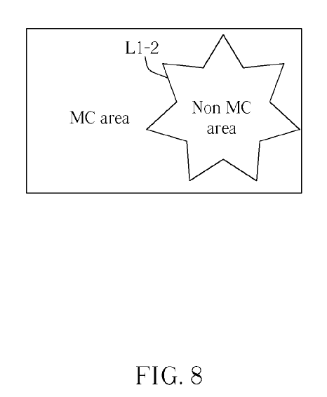

FIG. 8 illustrates another example of the boundary L1 shown in FIG. 6, i.e. the boundary L1-2, where the boundary shown in FIG. 8 is a boundary between an MC area and a non MC area. According to a second implementation choice of this embodiment with reference to FIG. 8, for the adjacent pixel pair p0 and q0, when an absolute value of a difference between the blending factor k(p0) of the pixel p0 and the blending factor k(q0) of the pixel q0 is greater than another threshold th3, i.e. the situation where |k(p0)−k(q0)|>th3 occurs, the adaptive post filter 120 respectively sets the two flags FTX(p0) and FTX(q0) regarding the pixels p0 and q0 as the first logical value ‘1’ (i.e. FTX(p0)=1 and FTX(q0)=1), indicating that the post filtering should be performed regarding the pixels p0 and q0. It should be noted that there is an exception for setting these flags as mentioned above. When a motion vector MV(n) of a specific pixel n out of the pixels p0 and q0 is zero, i.e. the situation where MV(n)=0 occurs, the adaptive post filter 120 forcibly sets the flag FTX(n) regarding the pixel n as the second logical value ‘0’ (i.e. FTX(n)=0), indicating that the post filtering should not be performed regarding the pixel n.

Thus, the adaptive post filter 120 determines whether to bypass the pixel value of the pixel under consideration or generates the filtered value of the pixel under consideration according to the flag FTX( ) regarding the pixel. In contrast to the first implementation choice mentioned above, similar descriptions for the second implementation choice are not repeated in detail here.

According to a third implementation choice of this embodiment with reference to the non MC area shown in FIG. 8, for the pixel p0, when the blending factor k(p2) of the pixel p2, the blending factor k(p1) of the pixel p1, the blending factor k(p0) of the pixel p0, the blending factor k(q0) of the pixel q0, and the blending factor k(q1) of the pixel q1 are all less than another threshold th4, i.e. the situation where k(p2)<th4 and k(p1)<th4 and k(p0)<th4 and k(q0)<th4 and k(q1)<th4 occurs, the adaptive post filter 120 sets the flags FTX(p0) regarding the pixel p0 as the first logical value ‘1’ (i.e. FTX(p0)=1), indicating that the post filtering should be performed regarding the pixel p0. It should be noted that there is an exception for setting the flag as mentioned above. When the motion vector MV(p0) of the pixel p0 is zero, i.e. the situation where MV(p0)=0 occurs, the adaptive post filter 120 forcibly sets the flag FTX(p0) regarding the pixel p0 as the second logical value ‘0’ (i.e. FTX(p0)=0), indicating that the post filtering should not be performed regarding the pixel p0.

Thus, the adaptive post filter 120 determines whether to bypass the pixel value of the pixel under consideration or generates the filtered value of the pixel under consideration according to the flag FTX( ) regarding the pixel. Descriptions for the third implementation choice similar to the first implementation choice are not repeated in detail here.

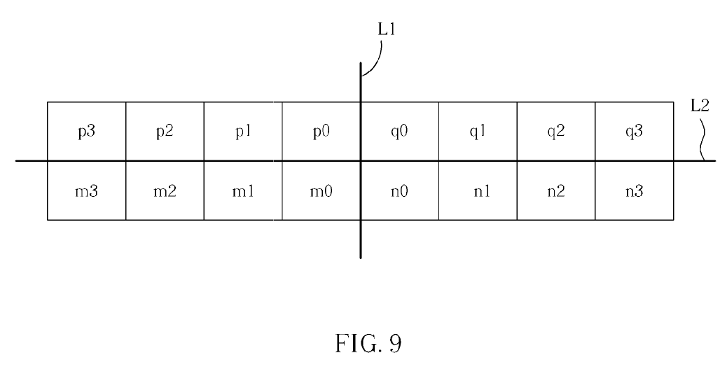

FIG. 9 illustrates two exemplary boundaries L1 and L2 between pixels considered by the adaptive post filter 120 according to a variation of the first embodiment. Differences between this variation and the first embodiment are described as follows. The post filtering in this variation is two dimensional filtering instead of one dimensional filtering as disclosed in the first embodiment. Thus, the flag FTX( ) in the first embodiment is extended to two flags FTX( ) and FTY( ) respectively corresponding to the X-direction and the Y-direction, and the low pass filtering function LPF_{X}(Pixel(X_LB), . . . , Pixel(X_UB)) is extended to a two dimensional low pass filtering function LPF(Pixel(X_LB, Y_LB), . . . , Pixel(X_UB, Y_UB)) with Y_LB and Y_UB respectively representing a lower bound and an upper bound of the pixel location along the Y-direction within the region.

According to this variation, if the flag FTX(p0) regarding the pixel p0, the flag FTX(m0) regarding the pixel m0, and the flag FTY(p0) regarding the pixel p0 are all eventually set as the first logical value ‘1’ by the adaptive post filter 120, the adaptive post filter 120 generates the filtered value PV′(p0) of the pixel p0 as follows:

PV′(p0)=LPF(p2, p1, p0, q0, q1, m2, m1, m0, n0, n1).

Descriptions for this variation similar to the first embodiment are not repeated in detail here.

Those skilled in the art will readily observe that numerous modifications and alterations of the device and method may be made while retaining the teachings of the invention.

What is claimed is:

1. A method for enhancing image quality of motion compensated interpolation, comprising:
generating an interpolated frame according to at least two source frames by analyzing motion estimation information of the two source frames; and
regarding a pixel under consideration within the interpolated frame, selectively performing post filtering according to motion estimation information of a region where the pixel is located.

2. The method of claim 1, wherein the motion estimation information represents motion vectors, and the step of selectively performing the post filtering further comprises:
determining whether a difference between a motion vector of the pixel and a motion vector of another pixel within the region reaches a threshold to determine whether to perform the post filtering.

3. The method of claim 1, wherein the post filtering is selectively performed further according to motion compensation information.

4. The method of claim 3, wherein the motion compensation information represents blending factors, and the step of selectively performing the post filtering further comprises:
determining whether a difference between a blending factor of the pixel and a blending factor of another pixel within the region reaches a threshold to determine whether to perform the post filtering.

5. The method of claim 3, wherein the motion compensation information represents blending factors, and the step of selectively performing the post filtering further comprises:
determining whether blending factors of a plurality of pixels within the region are all less than a threshold to determine whether to perform the post filtering.

6. The method of claim 1, wherein in the step of selectively performing the post filtering, the post filtering is two dimensional filtering.

7. The method of claim 1, wherein the motion estimation information represents motion vectors, and the step of selectively performing the post filtering further comprises:
when the motion vector of the pixel is zero, determining to not perform the post filtering.

8. The method of claim 7, wherein the step of selectively performing the post filtering further comprises:
when the motion vectors of a plurality of pixels within the region are zero, determining to not perform the post filtering.

9. The method of claim 1, wherein the post filtering represents blurring processing.

10. The method of claim 9, wherein the step of selectively performing the post filtering further comprises:
according to the motion estimation information, selectively performing low pass filtering on the region to generate a filtered value of the pixel.

11. An apparatus for enhancing image quality of motion compensated interpolation, comprising:
a motion compensated interpolator, for generating an interpolated frame according to at least two source frames by analyzing motion estimation information of the two source frames; and
an adaptive post filter, coupled to the motion compensated interpolator, regarding a pixel under consideration within the interpolated frame, the adaptive post filter selectively performing post filtering according to motion estimation information of a region where the pixel is located.

12. The apparatus of claim 11, wherein the motion estimation information represents motion vectors, and the adaptive post filter determines whether a difference between a motion vector of the pixel and a motion vector of another pixel within the region reaches a threshold to determine whether to perform the post filtering.

13. The apparatus of claim 11, wherein the adaptive post filter selectively performs the post filtering further according to motion compensation information.

14. The apparatus of claim 13, wherein the motion compensation information represents blending factors, and the adaptive post filter determines whether a difference between a blending factor of the pixel and a blending factor of another pixel within the region reaches a threshold to determine whether to perform the post filtering.

15. The apparatus of claim 13, wherein the motion compensation information represents blending factors, and the adaptive post filter determines whether blending factors of a plurality of pixels within the region are all less than a threshold to determine whether to perform the post filtering.

16. The apparatus of claim 11, wherein the post filtering is two dimensional filtering.

17. The apparatus of claim 11, wherein the motion estimation information represents motion vectors; and when the motion vector of the pixel is zero, the adaptive post filter determines to not perform the post filtering.

18. The apparatus of claim 17, wherein when the motion vectors of a plurality of pixels within the region are zero, the adaptive post filter determines to not perform the post filtering.

19. The apparatus of claim 11, wherein the post filtering represents blurring processing.

20. The apparatus of claim 19, wherein according to the motion estimation information, the adaptive post filter selectively performs low pass filtering on the region to generate a filtered value of the pixel.
